(19) United States
(12) Patent Application Publication
(10) Pub. No.: US 2015/0089852 A1
(43) Pub. Date: Apr. 2, 2015

(54) INFORMATIVE BRACELET AND A DISPENSER THEREOF

(71) Applicants: Alon Gabriel, Holon (IL); Ronen Gabriel, Halon (IL)

(72) Inventors: Alon Gabriel, Holon (IL); Ronen Gabriel, Halon (IL)

(21) Appl. No.: 14/040,758

(22) Filed: Sep. 30, 2013

(51) Int. Cl. G09F 3/00

(52) U.S. Cl. CPC G09F 3/005; G09F 2003/0202
USPC 40/633; 347/110

(57) ABSTRACT

An informative bracelet (10), comprising: a stripe (18); connecting means, connecting the ends of the stripe (18) to an annular form, thereby enabling wearing the annular form on a wrist of an individual (12); and an impression (22) of a telephone number of a guardian (14) of the individual (12); wherein the bracelet is adapted to prevent unintentional removal thereof by the individual (12), from his wrist; thereby, when the individual gets lost, allowing locating the guardian by calling the telephone number. In another aspect, the present invention is directed to an informative bracelet, for use for contacting a guardian of a lost individual, the bracelet comprising: an impression (22) of a telephone number of a guardian (14) of the individual (12).

### FIELD OF THE INVENTION

The present invention relates to the field of locating lost dependent individuals, such as children, elderly people, and so on.

### BACKGROUND OF THE INVENTION

U.S. Pat. No. 5,978,493 to Kravits et al. is considered by the Applicant of the present invention as the closest prior art. The Abstract thereof discloses “Information including images of the parent and child are stored in an integrated circuit device in a child's watch or bracelet. The device contains write only once, non-volatile, storage and contacts for coupling the device to data entry and reader stations. At the time of entry into a protected facility, information identifying the child and guardian, along with digitized photos of the child and the guardian, are stored in the non-volatile storage at an entry station. Once the identification information is written into the device at the entry station, the child's watch or bracelet is attached with a tamper proof seal to the child in such a way that it cannot be easily removed by the child. If, while in the protected premises, the child is lost, found and taken to a security station, the watch is removed from the child and placed in the reader at that station and the information retrieved.”

However, the technology described above has not yet provided satisfactory solutions to the problem of locating a lost individual such as a child, an elderly person, and so on, since the disclosed system is very cumbersome from the user's point of view, requires pre-registration of the individuals under care, and is especially limited to protected premises.

It is an object of the present invention to provide a solution to the above-mentioned and other problems of the prior art.

Other objects and advantages of the invention will become apparent as the description proceeds.

### SUMMARY OF THE INVENTION

In one aspect, the present invention is directed to an informative bracelet (10), comprising:
a stripe (18);
connecting means, connecting the ends of the stripe (18) to an annular form, thereby enabling wearing the annular form on a wrist of an individual (12); and
an impression (22) of a telephone number of a guardian (14) of the individual (12);

wherein the bracelet is adapted to prevent unintentional removal thereof by the individual (12), from his wrist;

thereby when the individual gets lost, allowing locating the guardian by calling the telephone number.

Preferably, the connecting means is a glued section (24) disposed on the stripe, and covered by an oilcloth (16). However, other connection means may also be used, such as a clip, a clamp, a fastener, and so on.

Preferably, the impression comprises textual information, but it also can comprise a barcode, a Q-code, and so on.

In another aspect, the present invention is directed to a dispenser of informative bracelets, the dispenser comprising:
an inputting module (e.g., a keyboard), for inputting a telephone number of a guardian to the system;
a dispensing module, for dispensing a bracelet on which the telephone number is impressed; and
a charging module, for charging the guardian for dispensing the bracelet.

According to one embodiment of the invention, the dispensing module comprises:
a roller (50) on which a stripe (18) is rolled, the stripe having glued sections (24) disposed thereon at the same distance from each other, each of the glued sections being covered by an oilcloth (16);
an impressing mechanism (52), for impressing the telephone number;
a cutting mechanism (58), for cutting the stripe (18); and
a pulling mechanism (54, 56, 60, 62), for pulling the stripe (18) towards an outlet (32) from which a bracelet is dispensed.

Preferably, the dispenser is placed in a public place.

In yet another aspect, the present invention is directed to an informative bracelet, for use for contacting a guardian of a lost individual, the bracelet comprising:
an impression (22) of a telephone number of a guardian (14) of the individual (12).

In yet another aspect, the present invention is directed to a method for contacting a guardian of a lost individual, the method comprising the steps of:
impressing a telephone number of the guardian on an informative bracelet; and
wearing the bracelet on a wrist of the individual. thereby when the individual gets lost, allowing locating the guardian by calling the telephone number.

Preferably, the bracelet is adapted to prevent unintentional removal thereof.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF THE DRAWINGS

Embodiments and features of the present invention are described herein in conjunction with the following drawings:

FIG. 1 pictorially illustrates a use of an individual that finds a lost child wearing an informative bracelet, according to one embodiment of the invention.

FIG. 2 schematically illustrates an informative bracelet, according to one embodiment of the invention.

FIG. 3 schematically illustrates an operation of preparing a dispensed informative bracelet according to one embodiment of the invention, to be worn by an individual.

FIG. 4 schematically illustrates an informative bracelet dispenser, according to one embodiment of the invention.

FIG. 5 is a sectional view schematically illustrating some mechanical elements of the dispensing mechanism of an informative bracelet dispenser, according to one embodiment of the invention.

It should be understood that the drawings are not necessarily drawn to scale.

### DETAILED DESCRIPTION OF PREFERRED EMBODIMENTS

The present invention will be understood from the following detailed description of preferred embodiments, which are meant to be descriptive and not limiting. For the sake of brevity, some well-known features, methods, systems, procedures, components, circuits, and so on, are not described in detail.

The term “informative bracelet” refers herein to a bracelet to be worn by an individual, which comprises informative information regarding the individual.

The present invention solves the above-mentioned problems by placing one or more dispensers of informative bracelets in public places. The information impressed on a dispensed bracelet is the telephone number of a guardian of the person wearing the bracelet. Thus, when a guardian and the person under care are in such a place, the guardian may purchase a bracelet with his telephone number dispensed thereon, and place it on the dependent person's hand. If the person gets lost, his guardian can be notified from the telephone number impressed on the bracelet.

Preferably, the bracelet is designed such that it cannot be removed by tearing, but rather by cutting and the like, thereby preventing an individual wearing the bracelet from unintentionally tearing it.

Thus, when the dependent individual is taken to a crowded place such as train station, a beach, and so on, his guardian purchases a bracelet on which his telephone number is impressed, and places it on the dependent's wrist. If the dependent gets lost, the people that find him can call the guardian's telephone number impressed on the bracelet.

The use of the dispenser should be straightforward. For example, the operation instructions to the client should direct him to provide charging means, such as credit card, cash, etc., and then to type his telephone number, and then to click on a SEND key, and the like. For this purpose, the dispenser may comprise a keypad, means for charging the guardian (such as by placing cash money in a dedicated slot, a credit card reader, or even typing in the credit card number), and a SEND key.

According to another embodiment of the invention, the guardian calls with his cellular telephone to a telephone number associated with the dispenser. Assuming the call is not anonymous, the telephone number from which the telephone call was made is impressed on the dispensed bracelet, and the telephone number is charged for the service. Of course, the user may be asked to provide a code for confirming his order.

According to yet another embodiment of the invention, an Internet site is provided, by which a user can order bracelets to be sent to his home address. Thus, the Internet Web site is a user interface by which a user can post an order.

As per the dispensing mechanism, it may use a rolled tape of bracelets, which passes (a) an impression station for impressing the telephone number of a bracelet; (b) a cutting station for cutting the bracelet to be dispensed from ten roll; and a motor for moving the tape.

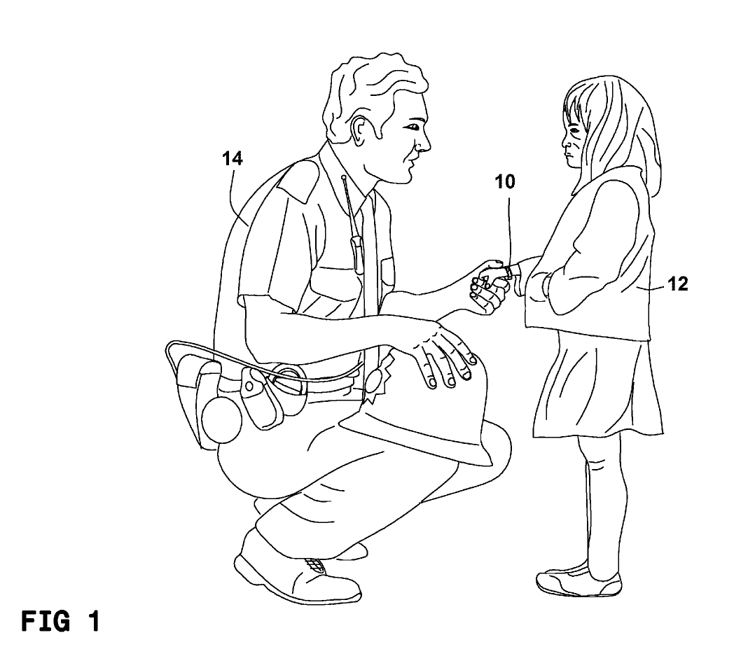

FIG. 1 pictorially illustrates a use of an individual that finds a lost child wearing an informative bracelet, according to one embodiment of the invention.

The informative bracelet according to one embodiment of the invention is marked herein by reference numeral 10. Reference numeral 12 denotes a dependent individual, such as a child or an elderly person, and reference numeral 14 denotes the guardian of individual 12.

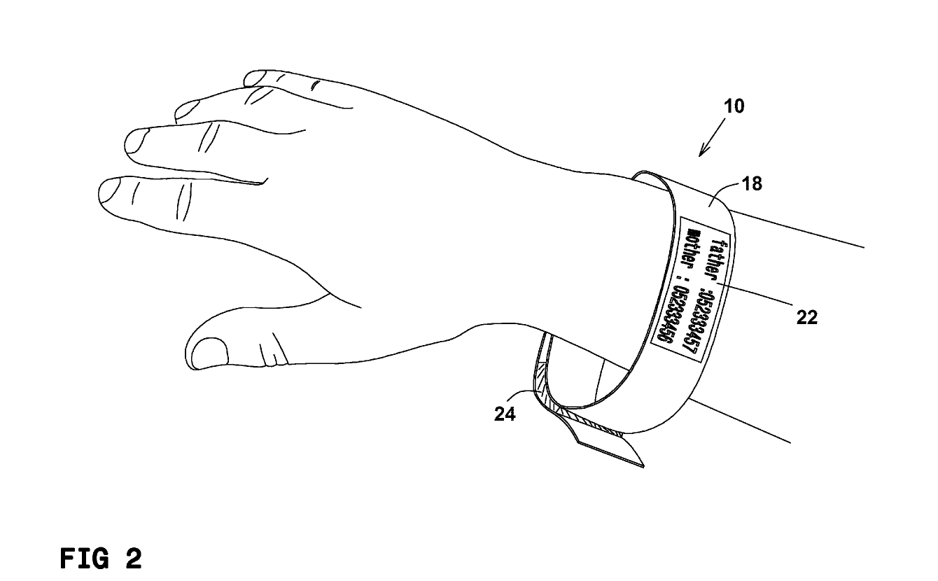

FIG. 2 schematically illustrates an informative bracelet, according to one embodiment of the invention.

The informative bracelet 10 is in the form of a rolled tape 18, comprising an impression 22 of the telephone numbers of a child's parents, and affixed by glued section 24.

The affixation is designed to be such that the individual wearing the bracelet cannot remove it, in order to prevent removing the bracelet unintentionally.

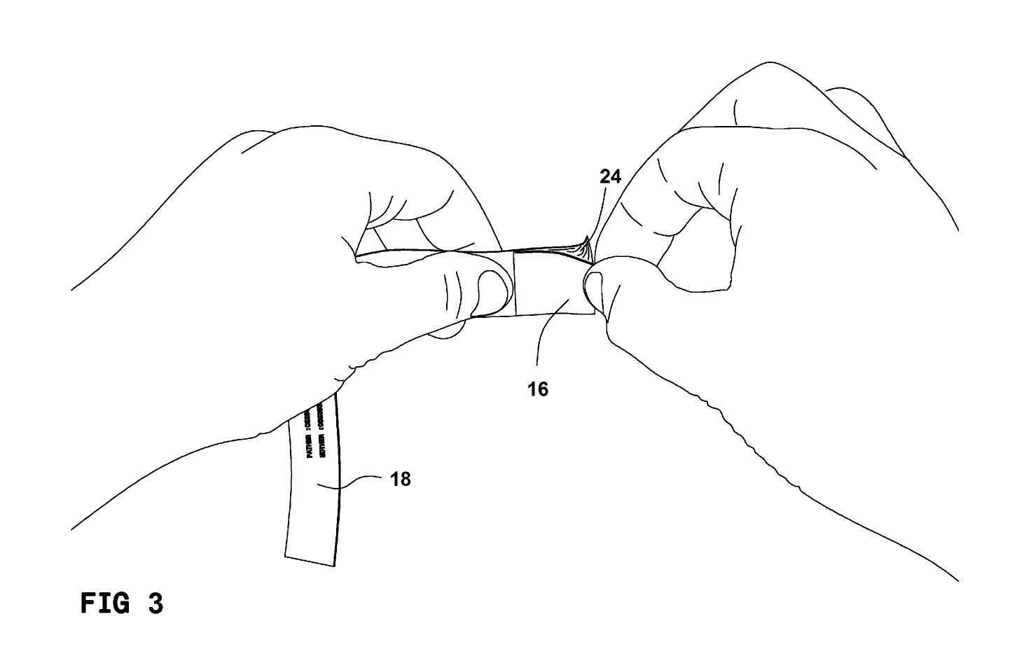

FIG. 3 schematically illustrates an operation of preparing a dispensed informative bracelet according to one embodiment of the invention, to be worn by an individual.

As illustrated, the bracelet comprises a tape 18, in which a section thereof 24 is glued, and covered by an oilcloth 16. By removing the oilcloth with a user's hands, the glued section is revealed.

The glue is of a type that binds the parts of tape 18 such that the individual wearing the bracelet cannot separate the glued parts by tearing, pulling, and so on.

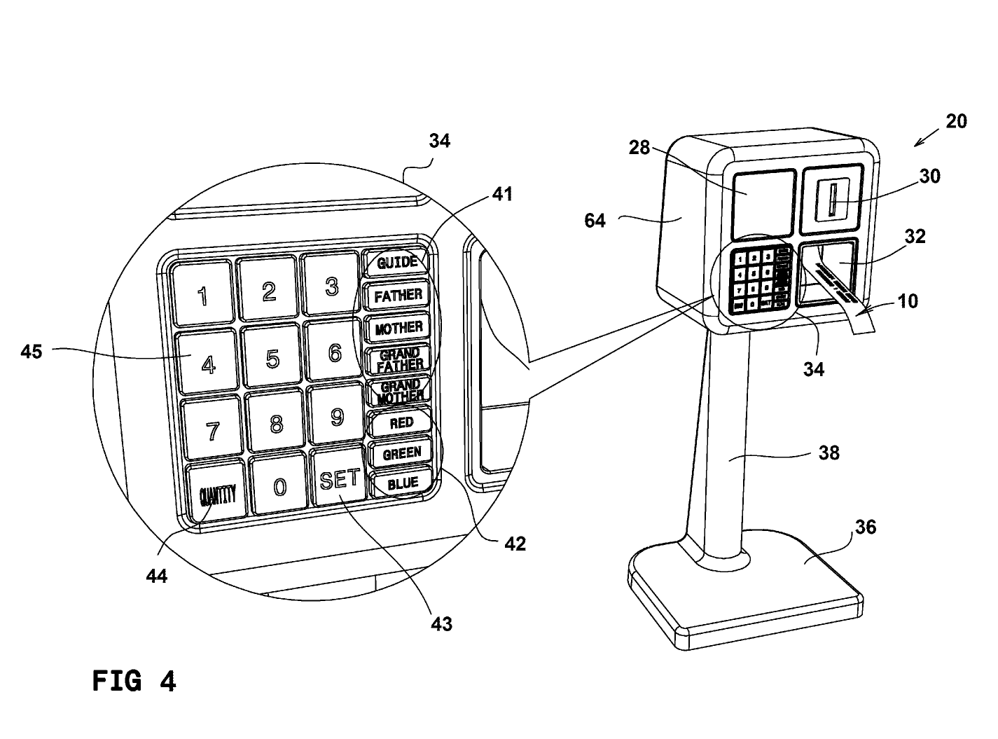

FIG. 4 schematically illustrates an informative bracelet dispenser, according to one embodiment of the invention.

The dispenser, which is marked herein by reference numeral 20, stands on a stand having a base 36 and a leg 38.

The dispenser may comprise a slot 30 for placing therein coins for paying a fee, a display 28, a keyboard 34, and an outlet 32 through which the informative bracelets are dispensed.

The user interface may be designed to guide the user as to how to order a bracelet. For example, the display may instruct the user to place a fee in coins into slot 30. Afterwards, the user is asked to press the keys that specify parameters with regard to the bracelet to be dispensed, such as printing color, content (e.g., telephone number), and so on. Finally the display instructs the user to press the SET button which will case generating a bracelet according to the parameters provided by the user, and dispensing the bracelet through outlet 32.

Of course, this is merely an example, and the user interface may be designed differently, in a simpler manner, a complicated manner, a more sophisticated manner, and so on.

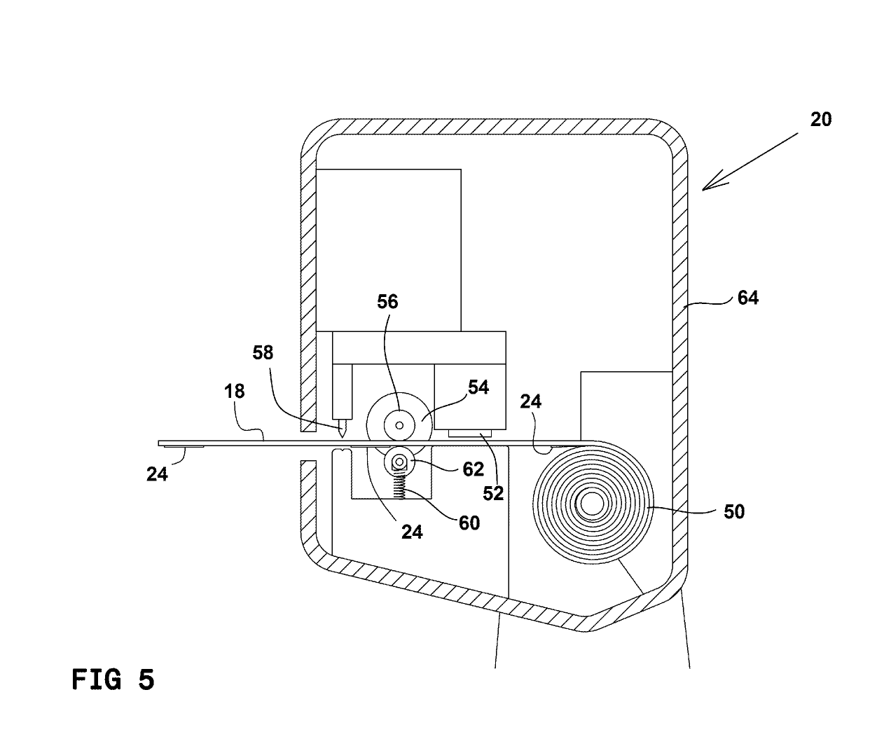

FIG. 5 is a sectional view schematically illustrating some mechanical elements of the dispensing mechanism of an informative bracelet dispenser, according to one embodiment of the invention.

According to this embodiment of the invention, the dispenser uses a roller 50 of a tape (stripe, and so on), on which are disposed glued sections 24, each covered by an oilcloth.

The mechanism that pulls tape 18 comprises motor 54 that rotates roller 56; roller 62, which is tangential to roller 56; and spring 60, which pushes roller 62 against roller 56. Tape 18 is disposed between rollers 56 and 62. Thus, as motor 54 rotates, tape 50 is pulled.

The first station the tape passes through is a printing station, which comprises a printer 52, which prints the information on tape 18.

The next station is a separation station, which comprises a cutter 58 for cutting the tape, thereby generating a bracelet.

In the figures and/or description herein, the following reference numerals have been mentioned:

numeral 10 denotes an informative bracelet, according to one embodiment of the invention;

numeral 12 denotes a dependent individual;

numeral 14 denotes a guardian of individual 12;

numeral 16 denotes an oilcloth;

numeral 18 denotes a tape, stripe, and so on;

numeral 20 denotes a dispenser of informative bracelets 10;

numeral 22 denotes an impression of the telephone number of guardian 14, at which the guardian can be reached;

numeral 24 denotes a glued section on stripe 18, for connecting the ends of the stripe to an annular form;

numeral 28 denotes a display;

numeral 30 denotes a coin slot, as an example for means for collecting a fee from a user;

numeral 32 denotes an outlet of dispenser 20, from which a bracelet is dispensed;

numeral 34 denotes a keyboard, as an example of input means;

numeral 36 denotes a base of the dispenser;

numeral 38 denotes a leg that connects casing 64 with base 36;

numeral 41 denotes dedicated keys for adding text (e.g., “Father”, “Mother”, etc.) to the impressed telephone number;

numeral 42 denotes keys for selecting the color of the impression;

numeral 43 denotes a submit key;

numeral 44 denotes a key for selecting the quality of the impression;

numeral 45 denotes a key of a digit;

numeral 50 denotes a roller of a tape (stripe, and so on);

numeral 52 denotes an impressing mechanism, such as a printer;

numeral 54 denotes a motor;

numeral 56 denotes a roller, rotated by motor 54;

numeral 58 denotes a cutter, as an example of a cutting mechanism;

numeral 69 denotes a spring;

numeral 62 denotes a roller, pushed by spring 60 against roller 56; and

numeral 64 denotes a casing of dispenser 20.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

What is claimed is:

1. An informative bracelet (10), comprising:
a stripe (18);
connecting means, for connecting the ends of said stripe (18) to an annular form, thereby enabling wearing said annular form on a wrist of an individual (12); and
an impression (22) of a telephone number of a guardian (14) of said individual (12);
wherein said bracelet is adapted to prevent unintentional removal thereof by said individual (12), from his wrist;
thereby when said individual gets lost, allowing locating said guardian by calling said telephone number.

2. A bracelet according to claim 1, wherein said connecting means is a glued section (24) disposed on said stripe, and covered by an oilcloth (16).

3. A bracelet according to claim 1, wherein said connecting means is selected from a group comprising: a clip, a clamp, a fastener, and so on.

4. A bracelet according to claim 1, wherein said impression comprises textual information.

5. A bracelet according to claim 1, wherein said impression comprises a barcode.

6. A bracelet according to claim 1, wherein said impression comprises a Q-code.

7. A dispenser of the informative bracelet of claim 1, said dispenser comprising:
an inputting module, for inputting a telephone number of said guardian to said system;
a dispensing module, for dispensing a bracelet on which said telephone number is impressed; and
a charging module, for charging said guardian for dispensing said bracelet.

8. A dispenser according to claim 7, wherein said dispensing module comprises:
a roller (50) on which a stripe (18) is rolled, said stripe having glued sections (24) disposed thereon at the same distance from each other, each of said glued sections being covered by an oilcloth;
an impressing mechanism (52), for impressing said telephone number;
a cutting mechanism (58), for cutting said stripe (18); and
a pulling mechanism (54, 56, 60, 62), for pulling said stripe (18) towards an outlet (32) from which a bracelet is dispensed.

9. A dispenser according to claim 7, wherein said inputting module comprises a keyboard.

10. A dispenser according to claim 7, placed in a public place.

11. An informative bracelet, for use for contacting a guardian of a lost individual, said bracelet comprising:
an impression (22) of a telephone number of a guardian (14) of said individual (12).

12. A method for contacting a guardian of a lost individual, said method comprising the steps of:
impressing a telephone number of said guardian on an informative bracelet; and
placing said bracelet on a wrist of said individual, thereby when said individual gets lost, allowing locating said guardian by calling said telephone number.

13. A method according to claim 12, wherein said bracelet is adapted to prevent unintentional removal thereof.
